(19) United States
(12) Patent Application Publication
(10) Pub. No.: US 2024/0309207 A1
(43) Pub. Date: Sep. 19, 2024

(54) PRODUCTION OF PU FOAMS USING RECYCLED POLYOLS

(71) Applicant: Evonik Operations GmbH, Essen (DE)

(72) Inventors: Ralph Marquardt, Frankfurt/Main (DE); Roland Hubel, Essen (DE); Annegret Terheiden, Alpen (DE); Felix Mühlhaus, Essen (DE)

(73) Assignee: Evonik Operations GmbH, Essen (DE)

(21) Appl. No.: 18/575,876

(22) PCT Filed: Jun. 28, 2022
(86) PCT No.: PCT/EP2022/067701

§ 371 Date: Jan. 1, 2024

(30) Foreign Application Priority Data
Jul. 2, 2021 (EP) 21183446.0

(51) Int. Cl. C08L 75/08; C08G 18/16; C08G 18/18; C08G 18/24; C08G 18/48; C08G 18/76; C08J 11/28

(52) U.S. Cl. CPC C08L 75/08; C08G 18/165; C08G 18/1825; C08G 18/244; C08G 18/4829; C08G 18/7621; C08J 11/28; C08G 2110/0008; C08G 2110/0083; C08J 2375/08; C08L 2201/08; C08L 2203/14

(57) ABSTRACT

A process for producing PU foams using recycled polyols can be performed by reacting at least one polyol component, which has a recycled polyol, with at least one isocyanate component in the presence of one or more catalysts that catalyse the isocyanate-polyol and/or isocyanate-water and/or isocyanate trimerization reactions. The process also includes at least one foam stabilizer and optionally one or more chemical or physical blowing agents. The employed recycled polyol has toluene 2,4-diamine, toluene 2,6-diamine, 2,2′-diaminodiphenylmethane, 2,4′-diaminodiphenylmethane and/or 4,4′-diaminodiphenylmethane, and specifically in a total amount of 0.00001% to 0.4% by weight, preferably 0.00002% to 0.2% by weight, more preferably 0.00005% to 0.1% by weight, based on the total recycled polyol.

The invention is in the field of polyurethanes and relates to the production of PU foams using recycled polyols

On account of their exceptional mechanical and physical properties, polyurethanes find use in a very wide variety of sectors. A particularly important market for a very wide variety of polyurethanes is the PU foams sector.

Polyurethanes (PU) are for the purposes of the present invention all reaction products derived from isocyanates, in particular from polyisocyanates, and appropriately isocyanate-reactive molecules, in particular polyols. They include inter alia polyisocyanurates, polyureas and isocyanate or polyisocyanate reaction products containing allophanates, biurets, uretdiones, uretonimines or carbodiimides.

Polyurethanes are now so widespread worldwide that recycling is becoming increasingly important for these materials too. In the state of the art, there accordingly already exists various recycling processes for the recovery of polyurethane waste. The known chemical recycling processes, such as the hydrolysis described for example in U.S. Pat. No. 5,208,379, glycolysis, acidolysis, aminolysis, hydrogenolysis, solvolysis and similar processes are aimed at depolymerization on a molecular level and in each case lead to polyol mixtures that can also sometimes be reused for PUR production. These polyol mixtures are referred to very generally as recycled polyols.

The basic aim is to reuse the recycled polyols for the production of polyurethanes. Against this background, it was the specific object of the present invention to make it possible to provide PU foams using recycled polyols without there being a deterioration in the quality of the resulting foams by comparison with PU foams produced using conventional polyols, including in particular when relatively large amounts of recycled polyols are used.

The above object is achieved by the subject matter of the invention. The invention provides a process for producing PU foams by reacting
(a) at least one polyol component, comprising recycled polyol, with
(b) at least one isocyanate component,
in the presence of
(c) one or more catalysts that catalyse the isocyanate-polyol and/or isocyanate-water and/or isocyanate trimerization reactions,
(d) at least one foam stabilizer and also
(e) optionally one or more chemical or physical blowing agents,
wherein the employed recycled polyol comprises toluene 2,4-diamine, toluene 2,6-diamine, 2,2′-diaminodiphenylmethane, 2,4′-diaminodiphenylmethane and/or 4,4′-diaminodiphenylmethane, and specifically in a total amount of 0.00001% to 0.4% by weight, preferably 0.00002% to 0.2% by weight, more preferably 0.00005% to 0.1% by weight, based on the total recycled polyol.

The proportion by weight of toluene 2,4-diamine, toluene 2,6-diamine, 2,2′-diaminodiphenylmethane, 2,4′-diaminodiphenylmethane and/or 4,4′-diaminodiphenylmethane in the recycled polyol is determined by HPLC analysis of 25 μl of a sample prepared by dissolving 25 mg of recycled polyol in 25 ml of aqueous 20 mmol/l diammonium hydrogen phosphate solution and acetonitrile (70:30), in each case against an internal calibration line (detector: DAD 220 nm). The precise methods are elucidated in more detail hereinbelow in the experimental section.

The subject matter of the invention makes it possible, even when using relatively large amounts of recycled polyol, to provide polyurethane foams that correspond to the quality of conventional polyurethane foams produced in the same way but using conventional polyols.

Through the high proportion of recycled polyol that can be achieved, the subject matter of the invention enables a significant increase in the total proportion of recycled raw materials in the polyurethane foams generated according to the invention by comparison with foams obtained from conventional polyols or using predominantly conventionally generated polyols, which is an important advance in respect of the recyclability of polyurethane foams.

A characteristic of recycled polyol in general that are obtained according to processes of the prior art is that these always contain a proportion of primary aromatic amines that are formed during the depolymerization of PU and can be removed from the recycled polyols only through laborious industrial separation methods such as distillation and/or extraction and/or washing processes. Such processes are however often resource-intensive and lead to high costs and wastes. Potential residual contents of toluene 2,4-diamine, toluene 2,6-diamine, 2,2′-diaminodiphenylmethane, 2,4′-diaminodiphenylmethane and/or 4,4′-diaminodiphenylmethane in recycled polyols can be problematic, since not only are these aromatic amines toxic, they can also have a disruptive effect in PU production. Particularly residual contents of toluene 2,4-diamine, toluene 2,6-diamine, 2,2′-diaminodiphenylmethane, 2,4′-diaminodiphenylmethane and/or 4,4′-diaminodiphenylmethane totalling >0.4% by weight can in typical PU foam formulations lead to instability or even collapse of the rising foam, with the result that no satisfactory PU foams would then be obtained. Moreover, when polyols having residual contents of toluene 2,4-diamine, toluene 2,6-diamine, 2,2′-diaminodiphenylmethane, 2,4′-diaminodiphenylmethane and/or 4,4′-diaminodiphenylmethane totalling >0.4% by weight are used in moulded foam, the more rapid reaction of the latter with isocyanates and the consequently accelerated assembly of the polymer can give rise to significant flow disturbances.

It has surprisingly been found in the context of this invention that recycled polyols, even ones having a varying total content of toluene 2,4-diamine, toluene 2,6-diamine, 2,2′-diaminodiphenylmethane, 2,4′-diaminodiphenylmethane and/or 4,4′-diaminodiphenylmethane ranging from 0.00001 to 0.4%, do in fact consistently result in PU foams having very good quality and that the resulting foams, including ones having varying total contents of toluene 2,4-diamine, toluene 2,6-diamine, 2,2′-diaminodiphenylmethane, 2,4′-diaminodiphenylmethane and/or 4,4′-diaminodiphenylmethane in the recycled polyol of between 0.00001% and 0.4% by weight, preferably 0.00002% to 0.2% by weight, more preferably 0.00005% to 0.1% by weight, based on the total recycled polyol, have comparable foam properties, even when the corresponding recycled polyols are used in large amounts.

In a preferred embodiment of the invention, recycled polyols having the abovementioned content of toluene 2,4-diamine, toluene 2,6-diamine, 2,2′-diaminodiphenylmethane, 2,4′-diaminodiphenylmethane and/or 4,4′-diaminodiphenylmethane are used in foams having an index of between 75 and 130, preferably between 85 and 125, more preferably between 90 and 120 and in particular between 95 and 115.

A surprising additional advantage that was also found was that, in the case of foams produced according to the invention and having an index of between 95 and 115, by comparison to a standard polyurethane foam (produced without recycled polyol), comparably small amounts of toluene 2,4-diamine, toluene 2,6-diamine, 2,2′-diaminodiphenylmethane, 2,4′-diaminodiphenylmethane and/or 4,4′-diaminodiphenylmethane totalling not more than 35 μg per 1 g of PU foam, preferably not more than 25 μg per 1 g of PU foam, more preferably not more than 25 μg per 1 g of PU foam, in particular not more than 10 μg per 1 g of PU foam, may be detected in the VDA 278 emission test, which is widely used in the automotive industry. The VDA is the German Association of the Automotive Industry (www.vda.de). The measurement principle and procedure for the VDA 278 are elucidated in more detail in the examples.

As a further advantage it was surprisingly found that the use of recycled polyols of the invention having the abovementioned contents of toluene 2,4-diamine, toluene 2,6-diamine, 2,2′-diaminodiphenylmethane, 2,4′-diaminodiphenylmethane and/or 4,4′-diaminodiphenylmethane can give rise to an advantageous cell-opening effect when used in moulded foams

The invention also enables the use of high amounts of corresponding recycled polyol accompanied by only an insignificant reduction in foam quality or none at all, or in a few cases even an improvement in foam quality compared with a foam obtained from conventionally produced polyol. It therefore corresponds to a preferred embodiment of the invention when the process of the invention uses, based on the total employed polyol component, more than 30% by weight, preferably more than 50% by weight, preferably more than 70% by weight, further preferably more than 80% by weight, in particular more than 95% by weight, of recycled polyol, wherein this recycled polyol has the content according to the invention of toluene 2,4-diamine, toluene 2,6-diamine, 2,2′-diaminodiphenylmethane, 2,4′-diaminodiphenylmethane and/or 4,4′-diaminodiphenylmethane, of in total 0.00001% to 0.4% by weight, preferably 0.00002% to 0.2% by weight, more preferably 0.00005% to 0.1% by weight, based on the total recycled polyol.

The employed recycled polyol is a polyol originating in particular from the recycling of polyurethane waste. Polyurethane waste includes any polyurethanes, in particular PU foams, that are no longer being used but are earmarked for disposal. It therefore corresponds to a preferred embodiment of the invention when the employed recycled polyol is a recycled polyol and/or recycled polymer polyol produced from polyurethane waste, preferably obtained from the depolymerization of PU foam, in particular of hot-cure flexible PU foam (standard PU foam), viscoelastic PU foam and/or HR PU foam, the recycled polyol and/or recycled polymer polyol having been obtained by solvolysis, preferably by hydrolysis, aminolysis, acidolysis or glycolysis, in particular by hydrolysis, as described for example in the as yet unpublished European patent applications under file references 20192354.7 or 20192364.6. The term “recycled polyol” encompasses for the purposes of the present invention also “recycled polymer polyol”. In principle, a residual content of primary aromatic amines is to be expected in the polyol obtained in all the mentioned processes for the recycling of PU foams produced using TDI and/or MDI, since these are released in the depolymerization step. What is key for the actual content in the recycled polyol obtained in each case is the process employed for recovery and purification after depolymerization (e.g. removal of aromatic amines and secondary components by distillation).

Following the depolymerization process, the recycled polyol may, through classical separation methods, be freed of other recycled products, in particular of the primary aromatic amines that can likewise be formed and of the added reagents for the particular depolymerization process. Some examples of methods for the purification and recovery of the recycled polyol from the crude mixture of recycling products present after the respective depolymerization step are mentioned below. One option for removing water from the crude mixture of recycling products consists of its removal by distillation. Toluene 2,4-diamine, toluene 2,6-diamine, 2,2′-diaminodiphenylmethane, 2,4′-diaminodiphenylmethane and/or 4,4′-diaminodiphenylmethane can be removed from the respective recycled polyol by distillation, by extraction with aromatic solvents or by washing with acidic wash aqueous solutions or by other methods from the crude mixture of recycling products; complete removal is however technically practicable only with difficulty and at high cost. For the purposes of the present invention, it is in each case essential that the contents of toluene 2,4-diamine, toluene 2,6-diamine, 2,2′-diaminodiphenylmethane, 2,4′-diaminodiphenylmethane and/or 4,4′-diaminodiphenylmethane stated in claim 1 are achieved or adjusted to, if necessary by the abovementioned purification steps or as shown in the experimental section. Any solid components that occur, such as recycling catalysts, salts or residual polyurethane components, can be removed from the crude product mixture/removed from the recycled polyols by filtration using various filter types.

The employed recycled polyol may in particular be obtained from a polyurethane hydrolysis comprising the reaction of the polyurethane with water in the presence of a base-catalyst combination (I) or (II),
where (I) comprises a base having a pK_{b} at 25° C. of 1 to 10 and a catalyst selected from the group consisting of quaternary ammonium salts containing an ammonium cation comprising 6 to 30 carbon atoms and organic sulfonates containing at least 7 carbon atoms, or where (II) comprises a base having a pK_{b} at 25° C. of <1 and a catalyst from the group of quaternary ammonium salts containing an ammonium cation having 6 to 14 carbon atoms in the case of an ammonium cation that does not contain a benzyl substituent, or else containing an ammonium cation having 6 to 12 carbon atoms in the case of an ammonium cation that contains a benzyl substituent. This corresponds to a preferred embodiment of the invention.

The use of recycled polyols obtained from the described hydrolysis process, which permits the very easy provision of recycled polyol having a content of toluene 2,4-diamine, toluene 2,6-diamine, 2,2′-diaminodiphenylmethane, 2,4′-diaminodiphenylmethane and/or 4,4′-diaminodiphenylmethane totalling 0.00001% to 0.4% by weight, preferably 0.00002% to 0.2% by weight, more preferably 0.00005% to 0.1% by weight, based on the total recycled polyol, corresponds to a particularly preferred embodiment of the invention. For the purposes of the present invention, it is here too essential that the contents of toluene 2,4-diamine, toluene 2,6-diamine, 2,2′-diaminodiphenylmethane, 2,4′-diaminodiphenylmethane and/or 4,4′-diaminodiphenylmethane stated in claim 1 are achieved or adjusted to, if necessary by the abovementioned purification steps or as shown in the experimental section.

Corresponding and preferred hydrolysis processes of PU materials are for example described in the as yet unpublished European patent applications under file references 20192354.7 or 20192364.6.

A particularly preferred variant, referred to here as preferred variant 1, of depolymerization by hydrolysis is described below.

In particular, it is preferable when the depolymerization of the polyurethane in step a) is effected using a base having a pK_{b} at 25° C. of 1 to 10, preferably 1 to 8, further preferably 1 to 7, in particular 1.5 to 6, and also a catalyst selected from the group consisting of (i) quaternary ammonium salts containing an ammonium cation comprising 6 to 30 carbon atoms and (ii) organic sulfonate containing at least 7 carbon atoms. This corresponds to a preferred embodiment of the invention.

Preferred bases comprise an alkali metal cation and/or an ammonium cation. Preferred bases are here alkali metal phosphates, alkali metal hydrogen phosphates, alkali metal carbonates, alkali metal silicates, alkali metal hydrogen carbonates, alkali metal acetates, alkali metal sulfites, ammonium hydroxides or mixtures of the above. Preferred alkali metals are Na, K or Li or mixtures of the above, in particular Na or K or mixtures thereof, preferred ammonium cation is NH₄⁺.

Particularly preferred bases are K₂CO₃, Na₂SiO₃, NH₄OH, K₃PO₄, or KOAc.

The base is preferably used in the form of a saturated alkaline solution in water, wherein the ratio by weight of saturated alkaline solution to PU is within a range preferably from 0.5 to 25, preferably 0.5 to 15, further preferably 1 to 10, in particular 2 to 7.

Preferred quaternary ammonium salts have the general structure: R₁R₂R₃R₄NX
with R₁, R₂, R₃ and R₄ identical or different hydrocarbon groups selected from alkyl, aryl and/or arylalkyl, R₁ to R₄ preferably being selected such that the sum of the carbon atoms in the quaternary ammonium cation is 6 to 14, preferably 7 to 14, in particular 8 to 13.
X is selected from halide, preferably chloride and/or bromide, hydrogen sulfate, alkyl sulfate, preferably methylsulfate or ethylsulfate, carbonate, hydrogen carbonate or carboxylate, preferably acetate or hydroxide.

Very particularly preferred quaternary ammonium salts are tributylmethylammonium chloride, tetrabutylammonium hydrogen sulfate, benzyltrimethylammonium chloride, tributylmethylammonium chloride and/or trioctylmethylammonium methylsulfate.

The organic sulfonate containing at least 7 carbon atoms that is likewise employable as catalyst preferably comprises alkyl aryl sulfonates, alpha-olefin sulfonates, petroleum sulfonates and/or naphthalene sulfonates.

Preferred temperatures for the depolymerization are 80° C. to 200° C., preferably 90° C. to 180° C., further preferably 95° C. to 170° C. and in particular 100° C. to 160° C.

Preferred reaction times for the depolymerization are 1 minute to 14 h, preferably 10 minutes to 12 h, preferably 20 minutes to 11 h and in particular 30 minutes to 10 h.

Preference is given to using for the depolymerization at least 0.5% by weight of catalyst based on the weight of the polyurethane, preferably 0.5% to 15% by weight, further preferably 1% to 10% by weight, even further preferably 1% to 8% by weight, further preferably still 1% to 7% by weight and in particular 2% to 6% by weight.

A preferred weight ratio of base to polyurethane is within a range from 0.01 to 50, preferably 0.1 to 25, in particular 0.5 to 20.

This related to the preferred variant 1 of the depolymerization.

Another further particularly preferred variant, referred to here as preferred variant 2, of depolymerization by hydrolysis is described below.

When the depolymerization of the polyurethane in step a) is effected using a base having a pK_{b} at 25° C. of <1, in particular 0.5 to −2, preferably 0.25 to −1.5, in particular 0 to −1, of a catalyst from the group of quaternary ammonium salts containing an ammonium cation having 6 to 14 carbon atoms in the case of an ammonium cation that does not contain a benzyl substituent, or else containing an ammonium cation having 6 to 12 carbon atoms in the case of an ammonium cation that contains a benzyl substituent, this is a further preferred embodiment of the invention.

Preferred bases are here alkali metal hydroxides, alkali metal oxides, alkaline earth metal hydroxides, alkali metal oxides or mixtures thereof. Preferred alkali metals are Na, K or Li or mixtures of the above, in particular Na or K or mixtures thereof; preferred alkaline earth metals are Be, Mg, Ca, Sr or Ba or mixtures thereof, preferably Mg or Ca or mixtures thereof. A very particularly preferred base is NaOH.

Preferred quaternary ammonium salts have the general structure: R₁R₂R₃R₄NX
with R₁, R₂, R₃ and R₄ identical or different hydrocarbon groups selected from alkyl, aryl and arylalkyl.
X is selected from halide, preferably chloride and/or bromide, hydrogen sulfate, alkyl sulfate, preferably methylsulfate or ethylsulfate, carbonate, hydrogen carbonate, carboxylate, preferably acetate or hydroxide.

Particularly preferred quaternary ammonium salts are here benzyltrimethylammonium chloride or tributylmethylammonium chloride.

Preferred temperatures for the depolymerization are 80° C. to 200° C., preferably 90° C. to 180° C., further preferably 95° C. to 170° C. and in particular 100° C. to 160° C.

Preferred reaction times for the depolymerization are 1 minute to 14 h, preferably 10 minutes to 12 h, preferably 20 minutes to 11 h and in particular 30 minutes to 10 h.

Preference is given to using for the depolymerization at least 0.5% by weight of catalyst based on the weight of the polyurethane, preferably 0.5% to 15% by weight, further preferably 1% to 10% by weight, even further preferably 1% to 8% by weight, further preferably still 1% to 7% by weight and in particular 2% to 6% by weight.

A preferred weight ratio of base to polyurethane is within a range from 0.01 to 25, preferably 0.1 to 15, preferably 0.2 to 10, in particular 0.5 to 5.

Preference is given to using an alkaline solution comprising base and water, wherein the base concentration is preferably greater than 5% by weight, preferably 5% to 70% by weight, preferably 5% to 60% by weight, further preferably 10% to 50% by weight, even further preferably 15% to 40% by weight, in particular 20% to 40% by weight, based on the weight of the alkaline solution. This related to the preferred variant 2 of the depolymerization.

The PU to be recovered in the PU depolymerization process may be any PU product; in particular it comprises a polyurethane foam, preferably rigid PU foam, flexible PU foam, hot-cure flexible PU foam (standard foam), viscoelastic PU foam, HR PU foam, hypersoft PU foam, semirigid PU foam, thermoformable PU foam and/or integral PU foam.

Recycled polyols that are for the purposes of the invention preferred preferably have a functionality (isocyanate-reactive groups per molecule) of 2 to 8. Preferably, the recycled polyols contain 2-8 OH groups. The number-average molecular weight of the recycled polyol is preferably within a range from 500 to 15 000 g/mol. The OH value of the recycled polyol is preferably 10 to 1200 mg KOH/g. The OH value can in particular be determined in accordance with DIN 53240:1971-12.

A preferred embodiment of the invention is when the employed recycled polyol is structurally a polyether polyol, it being possible to obtain such a recycled polyol preferably from the recycling of PU wastes, particularly PU foams, that had been obtained originally from conventional polyether polyols or from polyether polyols that had already been recycled one or more times.

In their original form prior to any recycling, polyether polyols may be produced by known processes, for example by anionic polymerization of alkylene oxides in the presence of alkali metal hydroxides, alkali metal alkoxides or amines as catalysts and with addition of at least one starter molecule, preferably containing 2 to 8 reactive hydrogen atoms in bonded form, or by cationic polymerization of alkylene oxides in the presence of Lewis acids, for example antimony pentachloride or boron trifluoride etherate, or by polymerization of alkylene oxides over double metal cyanide catalysis. Suitable alkylene oxides contain 2 to 4 carbon atoms in the alkylene radical. Examples are tetrahydrofuran, ethylene oxide, 1,3-propylene oxide, 1,2-propylene oxide and 1,2- or 2,3-butylene oxide; preference is given to using ethylene oxide and 1,2-propylene oxide. The alkylene oxides may be used individually, cumulatively, in blocks, in alternation or as mixtures. Starter molecules used are preferably di-, tri- or tetrahydric alcohols, such as ethylene glycol, propane-1,2- and -1,3-diol, diethylene glycol, dipropylene glycol, glycerol, trimethylolpropane, pentaerythritol, castor oil, higher polyfunctional polyols, in particular sugar compounds, for example glucose, sorbitol, mannitol and sucrose, polyhydric phenols, resols.

In a preferred embodiment of the invention, especially in the production of hot-cure flexible foams, it is possible to use di- or trifunctional polyether polyols in which the proportion of end groups formed through propoxylation (PO end groups) is preferably over 50%, more preferably over 80%, in particular those having a propylene oxide block or random propylene oxide and ethylene oxide block at the chain end, or those based solely on propylene oxide blocks. Such polyether polyols preferably have a functionality from 2 to 8, more preferably from 2 to 4, number-average molecular weights within a range from 500 to 8000, preferably 800 to 5000, more preferably 2500 to 4500 g/mol, and usually OH values within a range from 10 to 100, preferably 20 to 60, mg KOH/g.

According to a preferred embodiment of the invention, especially for production of moulded and highly resilient flexible PU foams, it is possible to use di- and/or trifunctional polyether polyols having preferably at least 50%, further preferably at least 80%, primary hydroxyl groups. Especially polyether polyols having an ethylene oxide end block —CH₂—CH₂—O—H may be used. Polyols for cold-cure polyurethane foams (known as HR polyols) can come under this category when the number-average molar mass is at the same time preferably over 4000 g/mol.

In a further preferred embodiment of the invention, it is possible to use for production of hypersoft PU foams optionally also further polyether polyols consisting largely of ethylene oxide, preferably ones containing more than 70% of ethylene oxide blocks, further preferably more than 90% of ethylene oxide blocks (hypersoft polyols). All polyether polyols described in the context of this preferred embodiment preferably have a functionality of 2 to 8 hydroxy groups, preferably 2 to 5 hydroxy groups, per molecule, preferably a number-average molecular weight of 500 to 8000 g/mol, preferably 800 to 7000 g/mol, and preferably OH values within a range from 5 to 100 mg KOH/g, preferably 20 to 60 mg KOH/g. Polyols having primary hydroxyl functions are in the case of hot-cure flexible foams preferably used not on their own, but preferably together with polyols having secondary hydroxyl groups.

In a further preferred embodiment of the invention, especially for the production of viscoelastic polyurethane foams, preference is given to using mixtures of different, preferably two to three, polyfunctional polyether polyols. The polyol combinations used consist preferably of a crosslinker polyol having a high functionality (>3) and having a low molecular weight, preferably having an OH value of 100 to 400 mg KOH/g, and/or a conventional flexible slabstock foam polyol and/or a HR polyol and/or a “hypersoft” polyether polyol, preferably having an OH value of between 20 to 40 mg KOH/g, having a high proportion of ethylene oxide and cell-opening properties. When HR polyols are used within a viscoelastic foam formulation, the proportion thereof in the polyol mixture is preferably always less than 50% . Independently of the recycled polyol of the invention, it is in the context of the present invention additionally possible to also use other polyols, in particular optional conventional polyols. Conventional polyols are polyols that do not originate from a recycling process.

It therefore corresponds to a preferred embodiment of the invention when the total employed polyol component comprises both recycled polyol of the invention and also additionally one or more further polyols.

The process of the invention makes it possible to provide all known PU foam types. According to a preferred embodiment of the invention, the resulting PU foam is a rigid PU foam, flexible PU foam, a hot-cure flexible PU foam (standard foam), a viscoelastic PU foam, an HR PU foam, a hypersoft PU foam, a semirigid PU foam, a thermoformable PU foam or an integral PU foam, preferably a hot-cure flexible PU foam, HR PU foam, hypersoft PU foam or viscoelastic PU foam. Hot-cure flexible PU foams are most preferred.

The production of the PU foams may in principle be carried out in the customary manner and as described in the prior art. It is well known to those skilled in the art A comprehensive overview is found in, for example, G. Oertel, Polyurethane Handbook, 2nd edition, Hanser/Gardner Publications Inc., Cincinnati, Ohio, 1994, pp. 177-247. Further details of the starting materials, catalysts and auxiliaries and additives that may be used can be found for example in Kunststoffhandbuch [Plastics Handbook], volume 7, Polyurethane [Polyurethanes], Carl-Hanser-Verlag Munich, 1st edition 1966, 2nd edition 1983 and 3rd edition 1993.

When, in the process of the invention for the production of PU foams, the reaction is carried out using
f) water,
g) one or more organic solvents,
h) one or more further stabilizers against oxidative degradation,
i) one or more flame retardants, and/or
j) one or more further additives, preferably selected from the group of surfactants, biocides, dyes, pigments, fillers, antistatic additives, crosslinkers, chain extenders, cell openers, fragrances, cell expanders, plasticizers, hardening promoters, aldehyde scavengers, additives for resistance of PU foams to hydrolysis, compatibilizers (emulsifiers), adhesion promoters, hydrophobization additives, flame-lamination additives, additives for preventing cold flow, additives that reduce compression set, additives for adjusting the glass transition temperature, temperature-controlling additives and/or odour-reducers, this is a further preferred embodiment of the invention.

The present invention further provides a composition suitable for production of polyurethane foam, comprising at least one polyol component, at least one isocyanate component, catalyst, foam stabilizer, blowing agent, optionally auxiliaries, wherein the polyol component comprises recycled polyol having a content of toluene 2,4-diamine, toluene 2,6-diamine, 2,2′-diaminodiphenylmethane, 2,4′-diaminodiphenylmethane and/or 4,4′-diaminodiphenylmethane of in total 0.00001% to 0.4% by weight, preferably 0.00002% to 0.2% by weight, more preferably 0.00005% to 0.1% by weight, based on the total recycled polyol.

According to a preferred embodiment of the invention, the composition of the invention has the feature that, based on the total polyol component, more than 30% by weight, preferably more than 50% by weight, preferably more than 70% by weight, further preferably more than 80% by weight, in particular more than 95% by weight, of recycled polyol is present, which has a content of toluene 2,4-diamine, toluene 2,6-diamine, 2,2′-diaminodiphenylmethane, 2,4′-diaminodiphenylmethane and/or 4,4′-diaminodiphenylmethane of in total 0.00001% to 0.4% by weight, preferably 0.00002% to 0.2% by weight, more preferably 0.00005% to 0.1% by weight, based on the total recycled polyol.

The compounds employed according to the invention, the production thereof, the use of the compounds for producing the PU foams and the PU foams themselves are hereinbelow described by way of example without any intention to limit the invention to these exemplary embodiments. Where ranges, general formulas or compound classes are specified below, these are intended to include not only the corresponding ranges or groups of compounds that are explicitly mentioned but also all subranges and subgroups of compounds that can be obtained by removing individual values (ranges) or compounds. Where documents are cited in the context of the present description, their content shall fully form part of the disclosure content of the present invention, particularly in respect of the matters referred to. Where figures are hereinbelow stated in per cent, these are percentages by weight unless otherwise stated. Average values specified hereinbelow are number averages unless otherwise stated. Where properties of a material are referred to hereinbelow, for example viscosities or the like, these are the properties of the material at 25° C. unless otherwise stated Where chemical (empirical) formulas are used in the present invention, the stated indices may be not only absolute numbers but also average values. For polymeric compounds, the indices preferably represent average values.

The process of the invention enables access to all PU foams. Preferred PU foams are for the purposes of the present invention flexible PU foams and rigid PU foams. Flexible PU foams and rigid PU foams are fixed technical terms. The known and fundamental difference between flexible foams and rigid foams is that flexible foam shows elastic behaviour and hence deformation is reversible. By contrast, rigid foam undergoes permanent deformation. Various foam subgroups that are in the context of the invention preferred are described in more detail hereinbelow.

In the context of the present invention, rigid polyurethane foam is in particular understood as meaning a foam to DIN 7726:1982-05 that has a compressive strength to DIN 53421:1984-06 of advantageously ≥20 kPa, preferably ≥80 kPa, more preferably ≥100 kPa, further preferably ≥150 kPa, particularly preferably ≥180 kPa. In addition, the rigid polyurethane foam to DIN EN ISO 4590:2016-12 advantageously has a closed-cell content of greater than 50%, preferably greater than 80% and more preferably greater than 90% Rigid PU foams are used mostly for insulation purposes.

Flexible PU foams are elastic, reversibly deformable and usually mostly open-celled. This means that the air can escape easily on compression. The umbrella term “flexible PU foam” here includes in particular the following foam types known to those skilled in the art, namely hot-cure flexible PU foam (standard PU foam), cold-cure PU foam, (also highly elastic or high-resilience foam), hypersoft PU foam, viscoelastic flexible PU foam and ester-type PU foams (from polyester polyols). The different flexible PU foam types are explained in more detail again and differentiated from one another hereinbelow.

The crucial difference between a hot-cure flexible PU foam and a cold-cure PU foam lies in the different mechanical properties. The distinction between hot-cure flexible PU foams and cold-cure flexible PU foams can be made in particular through the rebound resilience, also known as “ball rebound” (BR) or “resilience”. A method for determining the rebound resilience is described for example in DIN EN ISO 8307.2008-03. In this method, a steel ball having a fixed mass is allowed to fall from a defined height onto the test specimen and the height of the rebound as a % of the drop height is then measured. Hot-cure flexible PU foams have rebound values of preferably 1% to not more than 50% . The height of the rebound in the case of cold-cure flexible PU foams is preferably within the range >50% . The high rebound resilience of cold-cure flexible PU foams results from a relatively irregular cell size distribution A further mechanical criterion is the sag or comfort factor. Here, a foam specimen is compressed in accordance with DIN EN ISO 2439.2009-05 and the ratio of compressive stress at 65% and 25% compression is measured. Hot-cure flexible PU foams have a comfort factor of preferably <2.5. In the case of cold-cure flexible PU foams, the comfort factor is preferably >2.5. The production of cold-cure flexible PU foams employs in particular polyether polyols that are highly reactive towards isocyanates and have a high proportion of primary hydroxyl groups and number-average molar masses >4000 g/mol. In the case of hot-cure flexible PU foams, on the other hand, less reactive polyols having secondary OH groups and an average molar mass of <4000 g/mol are predominantly used. As well as cold-cure slabstock PU foams, moulded cold-cure PU foams, which are used for example in automotive seat cushioning, represent a core use of cold-cure PU foams.

Preference is according to the invention likewise given to hypersoft PU foams, which represent a subcategory of flexible PU foams. Hypersoft PU foams have compressive stresses determined to DIN EN ISO 3386-1:1997+A1:2010 of preferably <2.0 kPa and exhibit indentation hardnesses determined to DIN EN ISO 2439:2009-05 of preferably <80 N. Hypersoft PU foams can be produced by various known processes: through use of a so-called hypersoft polyol in combination with so-called standard polyols and/or through a special production process in which carbon dioxide is metered in during the foaming process. A pronounced open-cell structure of hypersoft PU foams gives them high air permeability, promotes moisture transfer in application products and helps avoid heat buildup. A particular feature of the hypersoft polyols employed for production of hypersoft PU foams is a very high proportion of primary OH groups of more than 60% .

A special class of flexible PU foams is that of viscoelastic PU foams (visco foams), which are likewise preferred according to the invention. These are also known as “memory foam” and are notable both for a low rebound resilience to DIN EN ISO 8307:2008-03 of preferably <15% and for a slow, gradual recovery after compression (recovery time preferably 2-13 s). In contrast to hot-cure flexible PU foams and cold-cure flexible PU foams, which have a glass transition temperature of less than −32° C., for viscoelastic PU foams the glass transition temperature is preferably shifted to within a range from −20 to +15° C. Such “structural viscoelasticity” in the case of open-cell viscoelastic PU foams, which is based essentially on the glass transition temperature of the polymer (also referred to as chemical visco foams), should be distinguished from a pneumatic effect. In the latter case, there is a relatively closed cell structure (low porosity). The low air permeability means that the air flows back in only gradually after compression, which results in slowed recovery (also referred to as pneumatic visco foams). In many cases the two effects are combined in a visco foam. PU visco foams are highly prized on account of their energy-and sound-absorbing properties.

A class of PU foams that is particularly important for applications in the automotive sector and has properties in between those of rigid and flexible foams is that of semirigid (semiflexible) PU foams. These too are preferred according to the invention. Like most PU foam systems, semiflexible foam systems also make use of the diisocyanate/water reaction and of the CO₂ evolved as a blowing agent for foam formation The rebound resilience is generally lower than that of classical flexible foams, especially cold-cure foams. Semiflexible foams have higher hardness than conventional flexible foams. A characteristic feature of semiflexible foams is their high open-cell content (preferably >90% of cells). The densities of semiflexible foams can be significantly greater than those of flexible and rigid foams.

The polyol components employed are preferably one or more polyols having two or more OH groups. It is obligatory for the polyol component according to the invention to comprise recycled polyol having a content of toluene 2,4-diamine, toluene 2,6-diamine, 2,2′-diaminodiphenylmethane, 2,4′-diaminodiphenylmethane and/or 4,4′-diaminodiphenylmethane of in total 0.00001% to 0.4% by weight, preferably 0.00002% to 0.2% by weight, more preferably 0.00005% to 0.1% by weight, based on the total recycled polyol. This has already been described further above. It is in addition optionally possible for further polyols also to be used.

Preferred further polyols that are optionally additionally employable are all polyether polyols and polyester polyols used for production of polyurethane systems, in particular polyurethane foam systems.

Polyether polyols are obtainable for example by reacting polyfunctional alcohols or amines with alkylene oxides Polyester polyols are based preferably on esters of polybasic carboxylic acids with polyhydric alcohols (usually glycols). The polybasic carboxylic acids can either be aliphatic (for example adipic acid) or aromatic (for example phthalic acid or terephthalic acid).

An important class of optionally employable polyols obtainable from natural oils such as palm oil or soybean oil are known as “natural oil-based polyols” (NOPs) and can be obtained on the basis of renewable raw materials. NOPs are of increasing interest for more sustainable production of PU foams in view of the long-term limits on the availability of fossil resources—oil, coal and gas—and against the background of rising crude oil prices and have already been described many times in the production of polyurethane foams (WO 2005/033167; US 2006/0293400, WO 2006/094227, WO 2004/096882, US 2002/0103091, WO 2006/116456 and EP 1678232). A number of these polyols are now commercially available from various manufacturers (WO 2004/020497, US 2006/0229375, WO 2009/058367). Depending on the base raw material (e.g. soybean oil, palm oil or castor oil) and subsequent processing, polyols having a varying property profile are obtained. It is possible here to distinguish essentially between two groups: a) polyols based on renewable raw materials that are modified such that they can be used to an extent of 100% for production of polyurethanes (WO2004/020497, US2006/0229375); b) polyols based on renewable raw materials that, because of the processing and properties thereof, are able to replace the petrochemical-based polyol only up to a certain proportion (WO2009/058367). The production of polyurethane foams from recycled polyols together with NOPs represents a preferred type of application of the invention.

A further class of optionally employable polyols comprises polyols obtained as prepolymers by reaction of polyol with isocyanate in a molar ratio of 100:1 to 5:1, preferably 50:1 to 10:1.

Yet another class of optionally employable polyols comprises what are known as filled polyols (polymer polyols). These contain dispersed solid organic fillers up to a solids content of 40% by weight or more. Employable polyols include for example inter alia:
SAN polyols: These are highly reactive polyols containing a dispersed copolymer based on styrene-acrylonitrile (SAN).
PUD polyols: These are highly reactive polyols containing polyurea particles in dispersed form.
PIPA polyols: These are highly reactive polyols containing polyurethane particles in dispersed form, produced for example by in-situ reaction of an isocyanate with an alkanolamine in a conventional polyol.

The solids content in the optional filled polyols, which depending on the application may preferably be between 5% and >40% by weight based on the polyol, is responsible for improved cell opening, with the result that the polyol becomes controllably foamable, especially with TDI, and no shrinkage of the foams occurs. The solids content thus acts as an essential processing aid. A further function is to control the hardness via the solids content, since higher solids contents result in a higher hardness of the foam.

Formulations comprising polyols that contain solids have markedly reduced inherent stability and therefore tend to require not only chemical stabilization through the crosslinking reaction but also additional physical stabilization.

Other optionally employable polyols are those known as cell-opener polyols. These are polyether polyols having a high ethylene oxide content, specifically a content preferably of at least 40% by weight, in particular of 50% to 100% by weight, based on the content of alkylene oxide.

A ratio of isocyanate component to polyol component that is preferred in the context of the present invention, and is expressed as an index, is within a range from 10 to 1000, preferably 40 to 350. This index describes the ratio of the amount of isocyanate actually used to the amount of isocyanate theoretically required for a stoichiometric ratio of isocyanate groups to isocyanate-reactive groups (e.g. OH groups, NH groups), multiplied by 100. An index of 100 represents a molar ratio of reactive groups of 1:1.

The isocyanate components used are preferably one or more isocyanates having two or more isocyanate functions. Any isocyanate may be used as isocyanate component in the process of the invention, in particular the aliphatic, cycloaliphatic, araliphatic and preferably aromatic polyfunctional isocyanates known per se. Suitable isocyanates for the purposes of the present invention have two or more isocyanate functions.

Suitable isocyanates for the purposes of the present invention are preferably any polyfunctional organic isocyanates, for example diphenylmethane diisocyanate (MDI), toluene diisocyanate (TDI), hexamethylene diisocyanate (HMDI) and isophorone diisocyanate (IPDI). Preference is likewise given to using the mixture known as “polymeric MDI” (“crude MDI” or polyphenyl polymethylene polyisocyanate), composed of MDI and analogues with a higher level of condensation having an average functionality of 2 to 4.

Particular preference is given to using diphenylmethane 2,4′-diisocyanate, diphenylmethane 2,2′-diisocyanate and/or polyphenyl polymethylene polyisocyanate (crude MDI), toluene 2,4-diisocyanate and/or toluene 2,6-diisocyanate or mixtures thereof.

MDI prepolymers are preferably also particularly suitable. Examples of particularly suitable isocyanates are detailed for example in EP 1712578, EP 1161474, WO 00/58383, US 2007/0072951, EP 1678232 and WO 2005/085310, which are hereby fully incorporated by reference.

It corresponds to a preferred embodiment of the invention when the isocyanate used, preferably diphenylmethane diisocyanate (MDI) and toluene diisocyanate (TDI), consists preferably to an extent of at least 20%, further preferably to an extent of at least 40%, particularly preferably to an extent of at least 60%, of recycled isocyanates.

In a preferred embodiment of the invention, the recycled isocyanates can be produced from the reaction of aromatic amine mixtures comprising toluene 2,4-diamine, toluene 2,6-diamine, 2,2′-diaminodiphenylmethane, 2,4′-diaminodiphenylmethane and/or 4,4′-diaminodiphenylmethane, the amine mixtures having been obtained preferably to an extent of at least 20%, further preferably to an extent of at least 35%, particularly preferably to an extent of at least 50%, from the recycling of polyurethanes, preferably polyurethane foams.

Suitable catalysts for possible use in the process of the invention for producing PU foams are preferably substances that catalyse the gel reaction (isocyanate-polyol), the blowing reaction (isocyanate-water) or the di- or trimerization of the isocyanate

It corresponds to a preferred embodiment of the invention when the catalyst used is selected from triethylenediamine, 1,4-diazabicyclo[2.2.2]octane-2-methanol, diethanolamine, N-[2-[2-(dimethylamino)ethoxy]ethyl]-N-methyl-1,3-propanediamine, 2-[[2-(2-(dimethylamino)ethoxy)ethyl]methylamino]ethanol, 1,1′-[(3-{bis[3-(dimethylamino)propyl]amino}propyl)imino]dipropan-2-ol, [3-(dimethylamino)propyl]urea, 1,3-bis[3-(dimethylamino)propyl]urea and/or amine catalysts of general structure (1a) and/or of structure (1b):

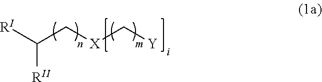

X comprises oxygen, nitrogen, hydroxyl, amino groups of the structure NR^{III} or NR^{III}R^{IV} or urea groups (N(R^{V}) C(O)N(R^{VI}) or N(R^{VII})C(O)NR^{VI}R^{VII}),
Y comprises amino groups NR^{VIII}R^{IX} or alkoxy groups OR^{IX},
R^{I,II} comprise identical or different, linear or cyclic, aliphatic or aromatic hydrocarbon groups having 1-8 carbon atoms that are optionally functionalized with an OH group and/or comprise hydrogen,
R^{III-IX} comprise identical or different, linear or cyclic, aliphatic or aromatic hydrocarbon groups having 1-8 carbon atoms that are optionally functionalized with an OH group, an NH or NH₂ group and/or comprise hydrogen,
m=0 to 4, preferably 2 or 3,
n=2 to 6, preferably 2 or 3,
i=0 to 3, preferably 0-2,

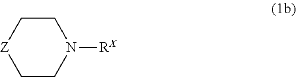

R^{X} comprises identical or different radicals consisting of hydrogen and/or linear, branched or cyclic, aliphatic or aromatic hydrocarbon groups having 1-18 carbon atoms, which may be substituted with 0-1 hydroxyl groups and/or 0-1 NH₂ groups,
Z comprises oxygen, N-R^{X} or CH₂.

A further class of suitable catalysts that may be used with preference in the process of the invention for producing PU foam are metal compounds of the metals Sn, Bi, Zn, Al or K, in particular Sn, Zn or Bi. The metal compounds can be divided into the subgroups of organometallic compounds, organometallic salts, organic metal salts and inorganic metal salts, which are explained hereinbelow.

The expression “metalorganic or organometallic compounds” encompasses for the purposes of the present invention in particular the use of metal compounds having a direct carbon-metal bond, here also referred to as metal organyls (e.g. tin organyls) or organometallic/organometal compounds (e.g. organotin compounds). The expression “organometallic or metalorganic salts” encompasses for the purposes of the present invention in particular the use of metalorganic or organometallic compounds having salt character, i.e. ionic compounds in which either the anion or cation is organometallic in nature (e.g. organotin oxides, organotin chlorides or organotin carboxylates). The expression “organic metal salts” encompasses for the purposes of the present invention in particular the use of metal compounds that do not have any direct carbon-metal bond and are at the same time metal salts in which either the anion or the cation is an organic compound (e.g. tin(II) carboxylates). The expression “inorganic metal salts” encompasses for the purposes of the present invention in particular the use of metal compounds or of metal salts in which neither the anion nor the cation is an organic compound, e g metal chlorides (e.g. tin(II) chloride).

Organic and organometallic metal salts that are suitable for use contain preferably alkoxide, mercaptate or carboxylate anions, such as acetate, 2-ethylhexanoate, octanoate, isononanoate, decanoate, neodecanoate, ricinoleate, laurate and/or oleate, particularly preferably 2-ethylhexanoate, ricinoleate, neodecanoate or isononanoate.

As a general rule, metal-containing catalysts that are suitable for use are preferably selected such that they do not have any troublesome intrinsic odour and are essentially toxicologically safe, and such that the resulting polyurethane systems, especially polyurethane foams, have the lowest possible degree of catalyst-related emissions.

It may be preferable to combine one or more metal compounds with one or more amine catalysts of formula (1a) and/or (1b).

In the production according to the invention of polyurethane foams, it may be preferable to exclude the use of organometallic salts, for example of dibutyltin dilaurate.

Suitable amounts in which these catalysts are used for the production of PU foam in the process of the invention depend on the type of catalyst and are preferably within a range from 0.01 to 5 pphp (=parts by weight based on 100 parts by weight of polyol) or from 0.1 to 10 pphp in the case of potassium salts.

Suitable amounts of water in the process of the invention depend on whether or not physical blowing agents are used in addition to water. In the case of purely water-blown foams, values range from preferably 1 to 20 pphp; when other blowing agents are additionally used, the amount of water used is reduced to usually e.g. 0 or e.g. 0.1 to 5 pphp. To achieve high foam densities, it is preferable that neither water nor any other blowing agent is used.

Physical blowing agents that are suitable for use for the purposes of the present invention are gases, for example liquefied CO₂, and volatile liquids, for example hydrocarbons having 4 or 5 carbon atoms, preferably cyclo-, iso- and n-pentane, hydrofluorocarbons, preferably HFC 245fa, HFC 134a and HFC 365mfc, but also olefinic hydrofluorocarbons such as HHO 1233zd or HHO1336mzzZ, hydrochlorofluorocarbons, preferably HCFC 141b, oxygen-containing compounds such as methyl formate and dimethoxymethane, or chlorinated hydrocarbons, preferably dichloromethane and 1,2-dichloroethane. Suitable blowing agents further include ketones (e.g. acetone) or aldehydes (e.g. methylal).

In addition to or in place of water and any physical blowing agents, the additive composition of the invention may also include other chemical blowing agents that react with isocyanates with gas evolution, examples being formic acid, carbamates or carbonates.

Foam stabilizers (referred to as stabilizers for the purposes of the invention) that can be used include the substances mentioned in the prior art. The compositions of the invention may advantageously contain one or more stabilizers. They are in particular silicon compounds containing carbon atoms, preferably selected from polysiloxanes, polydimethylsiloxanes, organomodified polysiloxanes, polyether-modified polysiloxanes and polyether-polysiloxane copolymers. Preferred silicon compounds are described by formula (1c).

[R¹₂R²SiO_{1/2}]ₐ[R¹₃SiO_{1/2}]_{b}[R¹₂SiO_{2/2}]_{c}[R¹R²SiO_{2/2}]_{d}[R³SiO_{3/2}]ₑ[SiO_{4/2}]_{f}Gg Formula (1c):

where
a=0 to 12, preferably 0 to 10, more preferably 0 to 8,
b=0 to 8, preferably 0 to 6, more preferably 0 to 2,
c=0 to 250, preferably 1 to 200, more preferably 1.5 to 150,
d=0 to 40, preferably 0 to 30, more preferably 0 to 20,
e=0 to 10, preferably 0 to 8, more preferably 0 to 6,
f=0 to 5, preferably 0 to 3, more preferably 0,
g=0 to 3, preferably 0 to 2.5, more preferably 0 to 2,
where:

$$a + b + c + d + e + f + g > 3 ,$$

$$a + b \geq 2 ,$$

G=independently identical or different radicals consisting of

(O_{1/2})ₙSiR¹ₘ—CH₂CHR⁵—R⁴—CHR⁵CH₂—SiR¹ₘ(O_{1/2})ₙ,

(O_{1/2})ₙSiR¹ₘ—CH₂CHR⁵—R⁴—CR⁵=CH₂,

(O_{1/2})ₙSiR¹ₘ—CH₂CHR⁵—R⁴—CR⁵=CR⁵—CH₃,
R⁴=independently identical or different divalent organic radicals, preferably independently identical or different divalent organic radicals of 1 to 50 carbon atoms, optionally interrupted by ether, ester, amide or (—SiR¹₂O—)ₓSiR¹₂ groups and optionally functionalized with OH groups. More preferably identical or different divalent organic radicals of 2 to 30 carbon atoms, optionally interrupted by ether, ester, amide or (—SiR¹₂O—)ₓSiR¹₂ groups and optionally functionalized with OH groups,
x=1 to 50, preferably 1 to 25, more preferably 1 to 10,
R⁵=independently identical or different alkyl radicals consisting of 1 to 16 carbon atoms, aryl radicals having 6 to 16 carbon atoms or hydrogen, preferably from the group of alkyl radicals having 1 to 6 carbon atoms or aryl radicals having 6 to 10 carbon atoms, more preferably methyl or hydrogen,
where:

$$n = 1 or 2 ,$$

$$m = 1 or 2 ,$$

$$n + m = 3 ,$$

R¹=identical or different radicals selected from the group of saturated or unsaturated alkyl radicals having 1 to 16 carbon atoms or aryl radicals having 6 to 16 carbon atoms or hydrogen or —OR⁶, preferably methyl, ethyl, octyl, phenyl or hydrogen, more preferably methyl or phenyl,
R²=independently identical or different polyethers obtainable by the polymerization of ethylene oxide and/or propylene oxide and/or other alkylene oxides such as butylene oxide and styrene oxide having the general formula (2) or an organic radical corresponding to formula (3)

—(R⁷)ₕ—O—[C₂H₄O]ᵢ—[C₃H₆O]ⱼ—[CR⁸₂CR⁸₂O]ₖ—R⁹, (2)

—Oₕ—R¹⁰, (3)
where
h=0 or 1,
R⁷=divalent organic radical, preferably divalent organic alkyl or aryl radical optionally substituted with —OR⁶, more preferably a divalent organic radical of type CₚH₂ₚ,
i=0 to 150, preferably 1 to 100, more preferably 1 to 80,
j=0 to 150, preferably 0 to 100, more preferably 0 to 80,
k=0 to 80, preferably 0 to 40, more preferably 0,
p=1 to 18, preferably 1 to 10, more preferably 3 or 4,
where

$$i + j + k \geq 3 ,$$

R³=identical or different radicals selected from the group of saturated or unsaturated alkyl radicals potentially substituted with heteroatoms, preferably identical or different radicals selected from the group of saturated or unsaturated alkyl radicals having 1 to 16 carbon atoms or aryl radicals having 6 to 16 carbon atoms potentially substituted with halogen atoms, more preferably methyl, vinyl, chloropropyl or phenyl,
R⁶=identical or different radicals selected from the group of saturated or unsaturated alkyl radicals having 1 to 16 carbon atoms or aryl radicals having 6 to 16 carbon atoms or hydrogen, preferably saturated or unsaturated alkyl radicals having 1 to 8 carbon atoms or hydrogen, more preferably methyl, ethyl, isopropyl or hydrogen,
R⁸=identical or different radicals selected from the group of alkyl radicals having 1 to 18 carbon atoms, potentially substituted with ether functions and potentially substituted with heteroatoms such as halogen atoms, aryl radicals having 6 to 18 carbon atoms, potentially substituted with ether functions, or hydrogen, preferably alkyl radicals having 1 to 12 carbon atoms, potentially substituted with ether functions and potentially substituted with heteroatoms such as halogen atoms, aryl radicals having 6 to 12 carbon atoms, potentially substituted with ether functions, or hydrogen, more preferably methyl, ethyl, benzyl or hydrogen,
R⁹=identical or different radicals selected from the group hydrogen, alkyl, —C(O)—R¹¹, —C(O)O—R¹¹ or —C(O)NHR¹¹, saturated or unsaturated, optionally substituted with heteroatoms, preferably hydrogen or alkyl radicals having 1 to 8 carbon atoms or acetyl, more preferably hydrogen, acetyl, methyl or butyl,
R¹⁰=identical or different radicals selected from the group of saturated or unsaturated alkyl radicals or aryl radicals potentially substituted with OH, ether, epoxide, ester, amine and/or halogen substituents, preferably saturated or unsaturated alkyl radicals having 1 to 18 carbon atoms or aryl radicals having 6-18 carbon atoms, optionally substituted with OH, ether, epoxide, ester, amine and/or halogen substituents, more preferably saturated or unsaturated alkyl radicals having 1 to 18 carbon atoms or aryl radicals having 6 to 18 carbon atoms substituted with at least one OH, ether, epoxide, ester, amine and/or halogen substituent,
R¹¹=identical or different radicals selected from the group of saturated or unsaturated alkyl radicals having 1 to 16 carbon atoms or aryl radicals having 6 to 16 carbon atoms, preferably saturated or unsaturated alkyl radicals having 1 to 8 carbon atoms or aryl radicals having 6 to 16 carbon atoms, more preferably methyl, ethyl, butyl or phenyl.

The foam stabilizers of formula (1c) may be used preferably in organic solvents such as dipropylene glycol, polyether alcohols or polyether diols blended in PU systems. In the case of mixtures of stabilizers of formula (1c), it is additionally preferably possible to use a compatibilizer. This compatibilizer may be selected from the group of aliphatic or aromatic hydrocarbons, more preferably aliphatic polyethers or polyesters.

Employable silicon compounds having one or more carbon atoms preferably include the substances mentioned in the prior art. Preference is given to using those silicon compounds that are particularly suitable for the particular type of foam. Suitable siloxanes are described for example in the following documents: EP 0839852, EP 1544235, DE 102004001408, WO 2005/118668, US 2007/0072951, DE 2533074, EP 1537159, EP 533202, U.S. Pat. No. 3,933,695, EP 0780414, DE 4239054, DE 4229402, EP 867465. The silicon compounds may be produced as described in the prior art. Suitable examples are described e.g. in U.S. Pat. No. 4,147,847, EP 0493836 and U.S. Pat. No. 4,855,379.

From 0.00001 to 20 parts by mass of foam stabilizers, in particular silicon compounds, per 100 parts by mass of polyol components may preferably be used.

Optional additives used may be all substances known from the prior art that are used in the production of polyurethanes, in particular of polyurethane foams, examples being blowing agents, preferably water for formation of CO₂, and, if necessary, further physical blowing agents, flame retardants, buffer substances, surfactants, biocides, dyes, pigments, fillers, antistatic additives, crosslinkers, chain extenders, cell openers, as described for example in EP 2998333A1, nucleating agents, thickeners, fragrances, cell expanders, as described for example in EP 2986661B1, plasticizers, hardening promoters, additives for preventing cold flow, as described for example in DE 250716103, WO 2017029054A1, aldehyde scavengers, as described for example in WO 2021/013607A1, additives for resistance of PU foams to hydrolysis, as described for example in US 2015/0148438A1, compatibilizers (emulsifiers), adhesion promoters, hydrophobization additives, flame-lamination additives, as described for example in EP 2292677B1, additives that reduce compression set, odour-reducers, additives for adjusting the glass transition temperature, temperature-controlling additives and/or additional catalytically active substances, in particular as defined above.

Optionally employable crosslinkers and optionally employable chain extenders are low-molecular-weight polyfunctional compounds that are reactive toward isocyanates. Examples of suitable compounds are hydroxyl-or amine-terminated substances such as glycerol, neopentyl glycol, 2-methylpropane-1,3-diol, dipropylene glycol, triethanolamine (TEOA), diethanolamine (DEOA) and trimethylolpropane and sugar compounds. Also employable as crosslinkers are polyethoxylated and/or polypropoxylated glycerol and/or sugar compounds, provided their number-average molecular weight is less than 1500 g/mol. The optional use concentration is preferably between 0.1 and 5 parts based on 100 parts of polyol, but can also deviate therefrom depending on the formulation. When crude MDI is used in in-situ foaming, it likewise takes on a crosslinking function. The content of low-molecular-weight crosslinkers can therefore be accordingly reduced as the amount of crude MDI increases

Suitable optional additional stabilizers against oxidative degradation are preferably all customary free-radical scavengers, peroxide scavengers, UV absorbers, light stabilizers, complexing agents for metal ion contaminants (metal deactivators). Preference is given to using compounds of the following substance classes or classes of substances containing the following functional groups: 2-hydroxybenzophenones, benzoic acids and benzoates, phenols, especially those having tert-butyl and/or methyl substituents on the aromatic ring, benzofuranones, diarylamines, triazines, 2,2,6,6-tetramethylpiperidines, hydroxylamines, alkyl and aryl phosphites, sulfides, zinc carboxylates, diketones.

Suitable optional flame retardants for the purposes of the present invention are all substances considered suitable for this purpose according to the prior art. Examples of preferred flame retardants are liquid organophosphorus compounds such as halogen-free organophosphates, for example triethyl phosphate (TEP), halogenated phosphates, e.g. tris(1-chloro-2-propyl) phosphate (TCPP), tris(1,3-dichloroisopropyl) phosphate (TDCPP) and tris(2-chloroethyl) phosphate (TCEP), and organic phosphonates, for example dimethyl methanephosphonate (DMMP), dimethyl propanephosphonate (DMPP), or oligomeric ethyl-ethylene phosphates or solids such as ammonium polyphosphate (APP) and red phosphorus. Suitable flame retardants further include halogenated compounds, for example halogenated polyols, and also solids such as expandable graphite and melamine.

The process of the invention makes it possible to produce polyurethane foams containing particularly high proportions of recycled polyols. The term polyurethane is for the purposes of the present invention to be understood in particular as a generic term for a polymer produced from di- or polyisocyanates and polyols or other isocyanate-reactive species, such as for example amines, wherein the urethane linkage is not necessarily the sole or predominating linkage type. Polyisocyanurates and polyureas are also expressly included.

The production according to the invention of polyurethane foams can be carried out by any processes familiar to those skilled in the art, for example by manual mixing or preferably with the aid of high-pressure or low-pressure foaming machines. The process of the invention may be executed continuously or batchwise. Batchwise execution of the process is preferable in the production of moulded foams, refrigerators, footwear soles or panels. A continuous process is preferable for producing insulation panels, metal composite elements, slabs or in spraying methods.

The invention further provides a polyurethane foam, preferably rigid PU foam, flexible PU foam, hot-cure flexible PU foam (standard foam), viscoelastic PU foam, HR PU foam, hypersoft PU foam, semirigid PU foam, thermoformable PU foam or integral PU foam, preferably hot-cure flexible PU foam, HR PU foam, hypersoft PU foam or viscoelastic PU foam, produced by a process of the invention as described hereinabove. Flexible PU foams are most preferred.

A very particularly preferred flexible polyurethane foam for the purposes of the present invention has in particular the following composition:

| Component | Parts by weight (pphp) |
|---|---|
| Polyol, comprising recycled | 100 |
| polyol of the invention | |
| (Amine) catalyst | 0.01 to 5 |
| Tin catalyst | 0 to 5, preferably 0.001 to 2 |
| Siloxane | 0.1 to 15, preferably 0.2 to 7 |
| Water | 0 to <15, preferably 0.1 to 10 |
| Further blowing agents | 0 to 130 |
| Flame retardant | 0 to 70 |
| Fillers | 0 to 150 |
| Further additives | 0 to 20 |
| Isocyanate index: | greater than 50 |

The polyurethane foams according to the invention may be used for example as refrigerator insulation, insulation panels, sandwich elements, pipe insulation, spray foam, 1- and 1.5-component can foam (a 1.5-component can foam is a foam that is produced by destroying a container in the can), imitation wood, modelling foam, packaging foam, mattresses, furniture cushioning, automotive seat cushioning, headrests, instrument panels, automotive interior trim, automotive headlining, sound absorption material, steering wheels, shoe soles, carpet backing foam, filter foam, sealing foam, sealants, adhesives, binders, lacquers or as coatings, or for producing corresponding products. This corresponds to a further subject matter of the invention.

The examples that follow describe the present invention by way of example, without any intention to limit the invention, the scope of application of which is apparent from the entirety of the description and the claims, to the embodiments specified in the examples.

### EXAMPLES

### Production and Characterization of Recycled Polyols

### Determination of Toluenediamine (TDA) in Recycled Polyols

All stated percentages (%) are unless otherwise stated percentages by weight.

The proportion by mass of toluenediamine is in the context of the present invention determined by HPLC from the sum of the 2,4-isomer and the 2,6-isomer.

For this, 25 mg of the polyol of the invention is dissolved in 25 ml of a solution consisting of aqueous 20 mM diammonium hydrogen phosphate solution and acetonitrile (70:30). An aliquot of the solution is analysed by HPLC. The analysis is carried out using an HPLC system equipped as follows:
Instrument: LC Agilent 1260
Column: Phenomenex Luna C18(2), 250 mm×4.6 mm, 5.0 μm
Oven temperature: 40° C.
Eluent: A: 20 mM (NH₄)₂HPO₄
B: Acetonitrile
Injected volume: 25 μl
Detector: DAD 220 nm
Flow: 1 ml/min
Gradient:

| Time [min] | B [%] |
|---|---|
| 0 | 17 |
| 5 | 17 |
| 10 | 75 |
| 19 | 75 |
| 20 | 17 |
| 25 | 17 |

Analysis time: 25 min

Toluene 2,4-diamine and 2,6-diamine are separated on the basis of their different polarity.

For evaluation, an external calibration with standard solutions of toluene 2,4-diamine and 2,6-diamine is carried out and a calibration line is generated. Through evaluation of the peak areas, the concentration of the analytes in the sample is then determined. The proportion by mass of the sum of toluene 2,4-diamine and 2,6-diamine is reported in % by weight based on the total mass of the respective recycled polyol.

### Determination of Diaminodiphenylmethane (MDA) in Recycled Polyols

All stated percentages (%) are unless otherwise stated percentages by weight.

The proportion by mass of diaminodiphenylamine (sum of the isomers 2,4′-MDA, 2,2′-MDA, 4,4′-MDA) is in the context of the present invention determined by HPLC.

For this, 25 mg of the polyol of the invention is dissolved in 25 ml of a solution consisting of aqueous 20 mM diammonium hydrogen phosphate solution and acetonitrile (70:30). An aliquot of the solution is analysed by HPLC. The analysis is carried out using an HPLC system equipped as follows:
Instrument: LC Agilent 1260
Column: Phenomenex Luna C18(2), 250 mm×4.6 mm, 5.0 μm
Oven temperature: 40° C.
Eluent: A: 20 mM (NH₄)₂HPO₄
B: Acetonitrile
Injected volume: 25 μl
Detector: DAD 220 nm
Flow: 1 ml/min
Gradient:

| Time [min] | B [%] |
|---|---|
| 0 | 30 |
| 5 | 30 |
| 10 | 75 |
| 19 | 75 |
| 20 | 30 |
| 25 | 30 |

Analysis time: 25 min

Diaminodiphenylamine (methylenediphenyldiamine) is separated on the basis of the different polarity of the matrix.

For evaluation, an external calibration with standard solutions of methylenediphenyldiamine is carried out and a calibration line is generated. Through evaluation of the peak areas, the concentration of the analyte in the sample is then determined

The proportion by mass of MDA (sum of the isomers) is reported in % by weight based on the total mass of the respective recycled polyol.

### Recycled Polyol 1 (Inventive)

The recycled polyol 1 of the invention was obtained by hydrolysis of polyurethane in the presence of a saturated K₂CO₃ solution and tetrabutylammonium hydrogen sulfate as catalyst:

A reactor from Parr (Parr Instrumental Company) equipped with a PTFE inner container and a mechanical stirrer was filled with 25 g of compressed foam pieces (approx. 1 cm×1 cm). The polyurethane foam used was produced according to formulation 1, in which the conventional polyol Arcol® 1104 had been used. To this was then added 75 g of saturated K₂CO₃ solution (pK_{b} 3.67 at 25° C.). The tetrabutylammonium hydrogen sulfate catalyst was then added to a content of 5% by weight based on the mass of the reaction mixture. The reactor was closed and the reaction mixture was heated to an internal temperature of 150° C. for 14 hours. At the end of the 14 hours, heating was stopped and the reaction mixture was cooled to room temperature. After opening the reactor, the reaction mixture was transferred to a round-bottomed flask. The water was removed by rotary evaporation and the residual reaction mixture was extracted with cyclohexane. The cyclohexane solution was washed with 1 N aqueous HCl solution and then dried over magnesium sulfate. Removal of the cyclohexane by rotary evaporation afforded recycled polyol 1 having a content of 0.0389% by weight of toluenediamine (TDA, sum of the 2,4-and the 2,6-isomer). The hydrolysis process was repeated so as to provide a sufficiently large amount of recycled polyol for the foaming experiments.

### Recycled Polyol 2 (Inventive)

The recycled polyol 2 of the invention was obtained by hydrolysis of polyurethane in the presence of a 30% sodium silicate solution and tributylmethylammonium chloride as catalyst:

A reactor from Parr (Parr Instrumental Company) equipped with a PTFE inner container and a mechanical stirrer was filled with 25 g of compressed foam pieces (approx. 1 cm×1 cm). The polyurethane foam used was produced according to formulation 1, in which the conventional polyol Arcol® 1104 had been used. To this was then added 75 g of sodium silicate solution (30% by weight solution in water).

The tributylmethylammonium chloride catalyst was then added to a content of 2.5% by weight based on the mass of the reaction mixture. The reactor was closed and the reaction mixture was heated to an internal temperature of 150° C. for 10 hours. At the end of the 10 hours, heating was stopped and the reaction mixture was cooled to room temperature. After opening the reactor, the reaction mixture was transferred to a round-bottomed flask. The water was removed by rotary evaporation and the residual reaction mixture was extracted with cyclohexane. The cyclohexane phase was washed with 1 N aqueous HCl solution and then dried over magnesium sulfate. Removal of the cyclohexane by rotary evaporation afforded recycled polyol 2 having a content of 0.1220% by weight of toluenediamine (TDA, sum of the 2,4-and the 2,6-isomer). The hydrolysis process was repeated so as to provide a sufficiently large amount of recycled polyol for the foaming experiments.

### Recycled Polyol 3 (Non-inventive)

The non-inventive recycled polyol 3 (prior art) was obtained by the hydrolysis of polyurethane in the presence of a 20% by weight NaOH solution and tetrabutylammonium hydrogen sulfate as catalyst:

A reactor from Parr (Parr Instrumental Company) equipped with a PTFE inner container and a mechanical stirrer was filled with 25 g of compressed foam pieces (approx. 1 cm×1 cm). The polyurethane foam used was produced according to formulation 1, in which the conventional polyol Arcol® 1104 had been used. To the foam pieces was then added 75 g of sodium hydroxide solution (20% by weight in water). The tetrabutylammonium hydrogen sulfate catalyst was then added to a content of 5% by weight based on the mass of the reaction mixture. The reactor was closed and the reaction mixture was heated to an internal temperature of 130° C. for 14 hours. At the end of the 14 hours, heating was stopped and the reaction mixture was cooled to room temperature. After opening the reactor, the reaction mixture was transferred to a round-bottomed flask. The water was removed by rotary evaporation and the residual reaction mixture was extracted with cyclohexane. The cyclohexane solution was washed with a small amount of 1 N aqueous HCl solution and then dried over magnesium sulfate. Removal of the cyclohexane by rotary evaporation afforded recycled polyol 3 having a toluenediamine content of 0.7260% by weight (TDA, sum of the 2,4-and the 2,6-isomer). The hydrolysis process was repeated so as to provide a sufficiently large amount of recycled polyol for the foaming experiments.

### Recycled Polyol 4 (Inventive)

The inventive recycled polyol 4 was obtained by the hydrolysis of polyurethane in the presence of a 20% by weight NaOH solution and tributylmethylammonium chloride as catalyst:

A reactor from Parr (Parr Instrumental Company) equipped with a PTFE inner container and a mechanical stirrer was filled with 25 g of compressed foam pieces (approx. 1 cm×1 cm). The polyurethane foam used was produced according to formulation 1, in which the conventional polyol Arcol® 1104 had been used. To the foam pieces was then added 75 g of sodium hydroxide solution (20% by weight in water)

The tributylmethylammonium chloride catalyst was then added to a content of 2.5% by weight based on the mass of the reaction mixture. The reactor was closed and the reaction mixture was heated to an internal temperature of 130° C. for 14 hours. At the end of the 14 hours, heating was stopped and the reaction mixture was cooled to room temperature. After opening the reactor, the reaction mixture was transferred to a round-bottomed flask. The water was removed by rotary evaporation and the residual reaction mixture was extracted with cyclohexane. The cyclohexane phase was washed with 1 N aqueous HCl solution and then dried over magnesium sulfate. Removal of the cyclohexane by rotary evaporation afforded recycled polyol 4 having a toluenediamine content of 0.0002% by weight (TDA, sum of the 2,4-and the 2,6-isomer), which was used for foaming experiments. The hydrolysis process was repeated so as to provide a sufficiently large amount of recycled polyol for the foaming experiments.

### Production of Flexible PU Foams

To test the recycled polyols in respect of their foaming properties and their influence on the physical properties of the foam, the following formulation was used for producing the hot-cure flexible foam. This means, for example, that 1.0 part (1.0 pphp) of a component refers to 1 g of said substance per 100 g of polyol.

TABLE 1
Formulation for production of hot-cure flexible PU foams

| Formulation 1 | Parts by mass (pphp) | |
|---|---|---|
| Polyol¹⁾ | 100 | pphp |
| Water | 4.00 | pphp |
| Kosmos ® T9²⁾ | 0.20 | pphp |
| Dabco ® DMEA³⁾ | 0.15 | pphp |
| Tegostab ® BF2370⁴⁾ | 1.0 | pphp |

| | |
|---|---|
| Desmodur ® T 80⁵⁾ | Variable, constant index of 105 |

1) Polyol: Standard polyether polyol Arcol® 1104 obtainable from Covestro; this is a glycerol-based polyether polyol having an OH value of 56 mg KOH/g and an average molar mass of 3000 g/mol or recycled polyols of the invention or non-inventive recycled polyol. The recycled polyols are produced from hot-cure flexible PU foams via a chemical recycling process. The recycling processes respectively used for production of the recycled polyol of the invention and of the non-inventive recycled polyol are described above.
2) Kosmos® T9, obtainable from Evonik Industries: tin(II) salt of 2-ethylhexanoic acid.
3) Dabco® DMEA: dimethylethanolamine, available from Evonik Industries. Amine catalyst for production of polyurethane foams
4) Polyether-modified polysiloxane, available from Evonik Industries.
5)Toluene diisocyanate T 80 (80% 2,4-isomer, 20% 2,6-isomer) from Covestro, 3 mPa·s, 48% NCO, functionality 2.

### General Procedure for Production of Hot-cure Flexible PU Foams

The polyurethane foams were produced in the laboratory in the form of what are called handmade foams. The production of the foams was carried out at 22° C. and air pressure of 762 mmHg according to the details below. The polyurethane foams according to formulation 1 were in each case produced using 150 g or 300 g of polyol. The other formulation constituents were adjusted accordingly. This meant, for example, that 1.0 part (1.0 pphp) of a component refers to 1 g of said substance per 100 g of polyol.

For the foams according to formulation 1, a paper cup was initially charged with the tin catalyst tin(II) 2-ethylhexanoate, polyol, the water, the amine catalysts and the respective foam stabilizer, and the contents were mixed with a disc stirrer at 1000 rpm for 60 s. After the first stirring, the isocyanate was added and incorporated with the same stirrer at 2500 rpm for 7s and the reaction then immediately transferred to a paper-lined box (for foams produced from 300 g of polyol: 30 cm×30 cm base area and 30 cm height, for foams produced from 150 g of polyol: 18 cm×18 cm base area and 18 cm height). After the foam had been poured in, it rose up in the foaming box. In the ideal case, the foam blew off on reaching the maximum rise height and then receded slightly. This opened the cell membranes of the foam bubbles to afford an open-pore cell structure in the foam.

To assess the properties, the following characteristic parameters were in the following section determined.

### Characterization of the PU Foams Produced

The foams produced were assessed on the basis of the following physical properties
a) Settling of the foam at the end of the rise phase (=fall-back):
   The settling, or the further rise, is calculated as the difference in the foam height immediately after blow-off and after 3 minutes after foam blow-off. The foam height is measured at the maximum in the centre of the foam crest by means of a needle secured to a centimetre scale. A positive value here describes the settling of the foam after blow-off; a negative value correspondingly describes the further rise of the foam.
b) Foam height is the height of the freely risen foam formed after 3 minutes. The foam height is reported in centimetres (cm).
c) Rise time
   The period of time between the end of mixing of the reaction components and the blow-off of the polyurethane foam. The rise time is reported in seconds (s).
d) Porosity
   The air permeability of the foam was determined based on DIN EN ISO 4638: 1993-07 by a dynamic pressure measurement on the foam. The measured dynamic pressure was reported in mm water column, lower dynamic pressure values being characteristic of a more open foam. The values were measured within a range from 0 to 300 mm water column. The dynamic pressure was measured by means of an apparatus comprising a nitrogen source, reducing valve with pressure gauge, flow-regulating screw, wash bottle, flowmeter. T-piece, applicator nozzle and a graduated glass tube filled with water. The applicator nozzle has an edge length of 100×100 mm, a weight of 800 g, an internal diameter at the outlet opening of 5 mm, an internal diameter at the lower applicator ring of 20 mm and an external diameter at the lower applicator ring of 30 mm.
   The measurement is carried out by setting the nitrogen inlet pressure to 1 bar by adjusting the reducing valve and setting the flow rate to 480 l/h. The amount of water in the graduated glass tube is set so that no pressure difference builds up and none can be read off. For the measurement on the test specimen having dimensions of 250×250×50 mm for foams produced from 300 g of polyol, or 150×150×50 mm for foams produced from 150 g of polyol, the applicator nozzle is applied to the corners of the test specimen, flush with the edges, and also once to the (estimated) centre of the test specimen (in each case on the side having the greatest surface area). The result is read off when a constant dynamic pressure has been established. The evaluation is based on the calculated average of the five measurements obtained.
e) Number of cells per cm (cell count): This is determined visually on a cut surface (measured to DIN EN 15702:2009-04).
f) Hardness CLD 40% to DIN EN ISO 3386-1:1997+A1:2010 Measured values are reported in kilopascals (kPa).
g) Compression set
   Five test specimens having dimensions of 5 cm×5 cm×2.5 cm were in each case cut out of the finished foams. The starting thickness was measured. Compression set was measured no earlier than 72 h after production in accordance with DIN EN ISO 1856:2018-11. The test specimens were placed between the plates of the deforming device and were compressed by 90% of their thickness (i.e. to 2.5 mm). Within 15 minutes, the test specimens were placed in an oven at 70° C. and left therein for 22 h. At the end of this time, the apparatus was removed from the oven, the test specimens were removed from the apparatus within 1 min, and they were placed on a wood surface. After relaxing for 30 min, the thickness was measured again and the compression set was calculated. The results are reported in per cent according to the following formula: DVR=(d0−dr)/d0×100%
h) Tensile strength and elongation at break to DIN EN ISO 1798: 2008-2008-04. Measured values for tensile strength are reported in kilopascals (kPa) and measured values for elongation at break in per cent (%).
i) Rebound resilience to DIN EN ISO 8307:2008-03. Measured values are reported in per cent (%).
j) Emissions of the PU foams, determined in accordance with VDA 278
   Measurement principle
   The materials are characterized in respect of the nature and amount of the organic substances that can be outgassed from them. For this, two semiquantitative totals are determined, which allow estimation of the emission of volatile organic compounds (VOC value) and of the fraction of condensable substances (FOG value). Individual substances in the emission are also determined. In the analysis, the samples are thermally extracted and the emissions are separated by gas chromatography and detected by mass spectrometry. The total concentrations thus obtained for the VOC fraction are calculated in toluene equivalents and give the VOC value as the result; the FOG fraction is represented in hexadecane equivalents and gives the FOG value.

The analytical method is used for the determination of emissions from non-metallic materials used for moulded parts in motor vehicles, which also include foams.

In thermal desorption analysis (TDA), small amounts of material are heated in a desorption tube in a defined manner and the volatile substances emitted during heating are cryofocused by means of an inert gas stream in a cold trap of a temperature-programmable vaporizer. At the end of the heating phase, the cold trap is rapidly heated to 280° C. This is accompanied by vaporization of the focused substances. These are then separated in the gas-chromatography separation column and detected by mass spectrometry. Calibration with reference substances permits semiquantitative estimation of the emission, expressed in “μg/g”. The quantitative reference substances used are toluene for the VOC analysis (VOC value) and n-hexadecane for the FOG value. Signal peaks can be assigned to substances on the basis of their mass spectra and retention indices. Source: VDA 278/10.2011, www.vda.de

### Analytics

### Test Specimen: Sample Preparation, Sampling and Specimen Dimensions

After production of the PU foams, they are stored at 21° C. and approx. 50% relative humidity for 24 hours. Specimens are then taken at suitable and representative sites distributed uniformly across the width of the PU specimen. The foams are then wrapped in aluminium foil and sealed in a polyethylene bag.

The amount of the foam samples introduced into the desorption tube is in each case 10-15 mg.

### Test Procedure: VOC/FOG Thermal Desorption

Immediately after obtaining the sealed test specimens, these are sent for direct determination. The samples are weighed out on an analytical balance to an accuracy of 0.1 mg before starting the analysis and the corresponding amount of foam is placed centrally in the desorption tube. A helium stream is passed over the sample and the latter heated to 90° C. for 30 minutes. All volatiles are collected in a cold trap cooled with liquid nitrogen. After 30 minutes the cold trap is heated to 280° C. The vaporizing substances are separated from one another by means of the described gas chromatography column and then analysed by mass spectroscopy.

### GC-MS Instrument Parameters

The following instrument was used for the analysis:
Supplied by Gerstel
D-45473 Mühlheim an der Ruhr,
Eberhard-Gerstel-Platz 1 TDS-3/KAS-4
Tenax® desorption tubes
Agilent Technologies 7890A (GC)/5975C (MS)
Column: HP Ultra2 (50 m, 0.32 mm, 0.52 μm)
Camer gas: Helium

TABLE 2
Foaming results for the hot-cure flexible PU foams produced according
to formulation 1, Table 1, with 150 g of polyol using recycled
polyols 1, 2 and 3 and the conventional polyol Arcol ® 1104.

| Foam specimen | #1 | #2 | #3 | #4 |
|---|---|---|---|---|
| Arcol ® 1104, OH value 56, reference, | 100 | | | |
| (pphp) | | | | |
| Recycled polyol 1 (inventive), TDA | | 100 | | |
| 0.0386% by weight, OH value 57 mg | | | | |
| KOH/g, (pphp) | | | | |
| Recycled polyol 2 (inventive), TDA | | | 100 | |
| 0.1220% by weight, OH value 62 mg | | | | |
| KOH/g, (pphp) | | | | |
| Recycled polyol 3 (non-inventive), | | | | 100 |
| TDA 0.7260% by weight, OH value | | | | |
| 65 mg KOH/g, (pphp) | | | | |
| Index | 105 | 105 | 105 | 105 |
| Rise time (s) | 111 | 110 | 111 | — |
| Foam height (cm) | 29.2 | 27.7 | 28.4 | — |
| Settling (cm) | 0.3 | 0.1 | −0.1 | — |
| Cell count (cm⁻¹) | 13 | 14 | 14 | — |
| Porosity (mm water column) | 9 | 12 | 10 | — |
| Hardness CLD 40% (kPa) | 4.5 | 4.0 | 4.6 | — |
| Elongation at break (%) | 119.1 | 127.4 | 124.4 | — |
| Tensile strength (kPa) | 100.1 | 99.9 | 103.5 | — |
| Rebound resilience (%) | 37.0 | 39.8 | 36.2 | — |
| TDA emissions* in μg based on 1 g | <5 | <5 | <5 | <5 |
| of PU foam in accordance with VDA | | | | |
| 278 | | | | |
| Comments | Standard | Standard | Standard | Collapse |
| | foam | foam | foam | |

*Total VOC values and FOG values of the isomers toluene 2,4-diamine and toluene 2,6-diamine.

The results in Table 2 compare the foamings of recycled polyols 1 and 2 of the invention and of the non-inventive recycled polyol 3 with those of Arcol® 1104. The three recycled polyols 1, 2 and 3 were all obtained from polyurethane foams originally produced with Arcol® 1104, consequently Arcol® 1104 represents the original polyol and serves as the reference. The comparison of the properties of foams #1, #2 and #3 shows that recycled polyols 1 and 2 of the invention afford foams comparable to that of reference foam #1 obtained from Arcol® 1104. Only the rise height is for #2 and #3 marginally less than that of reference foam #1. The use of the non-inventive recycled polyol 3 results in collapse of the foam. Surprisingly, all the foams, irrespective of the initial concentration of the amine in the recycled polyol, showed the same TDA emissions (sum of VOC values and FOG values for toluene 2,4-diamine and toluene 2,6-diamine) of <5 μg based on 1 g of PU foam, measured in accordance with VDA 278.

TABLE 3
Foaming results for the hot-cure flexible PU foams produced according to
formulation 1, Table 1, with in each case 300 g of polyol component using
recycled polyols 2 and 4 and the conventional polyol Arcol ® 1104

| Foam specimen | #5 | #6 | #7 |
|---|---|---|---|
| Arcol ® 1104, OH value 56, reference, | 100 | | 30 |
| Recycled polyol 4 (inventive), TDA 0.0002% | | 100 | |
| by weight, OH value 54 mg KOH/g, (pphp) | | | |
| Recycled polyol 2 (inventive), TDA 0.1220% | | | 70 |
| by weight, OH value 60 mg KOH/g, (pphp) | | | |
| Index | 105 | 105 | 105 |
| Rise time (s) | 117 | 122 | 122 |
| Foam height (cm) | 24.0 | 24.1 | 24.0 |
| Settling (cm) | 0.2 | 0.2 | 0.0 |
| Cell count (cm⁻¹) | 14 | 14 | 14 |
| Porosity (mm water column) | 15 | 10 | 8 |
| Hardness CLD 40% (kPa) | 3.4 | 3.5 | 3.7 |
| Elongation at break (%) | 159 | 148 | 157 |
| Tensile strength (kPa) | 113 | 116 | 128 |
| Rebound resilience (%) | 43.2 | 43.2 | 42.5 |
| Compression set 90%, 22 h at 70° C. (%) | 5.2 | 7.5 | 6.9 |
| Comments | Standard foam | Standard foam | Standard foam |

The results in Table 3 compare the foamings of recycled polyols 2 and 4 of the invention. The comparison of the properties of foams #5 and #6 shows that recycled polyols 4 of the invention afford a foam comparable to that of reference foam #5 obtained from Arcol® 1104. The use of 70 pphp of recycled polyol 2 together with 30 pphp of reference polyol Arcol@ 1104 permits the production of foam #7, the properties of which correspond essentially to those of foam #5 and #6.

1. A process for producing a PU foam, the process comprising:
reacting
(a) at least one polyol component, comprising a recycled polyol, with
(b) at least one isocyanate component,
in the presence of
(c) at least one or more catalysts that catalyse an isocyanate-polyol and/or isocyanate-water and/or isocyanate trimerization reactions,
(d) at least one foam stabilizer, and also
(e) optionally at least one or more chemical or physical blowing agents, wherein said recycled polyol comprises toluene 2,4-diamine, toluene 2,6-diamine, 2,2′-diaminodiphenylmethane, 2,4′-diaminodiphenylmethane and/or 4,4′-diaminodiphenylmethane, in a total amount of 0.00001% to 0.4% by weight based on a total recycled polyol.

2. The process according to claim 1, wherein the PU foam is a rigid PU foam, a flexible PU foam, a hot-cure flexible PU foam, a viscoelastic PU foam, an HR PU foam, a hypersoft PU foam, a semirigid PU foam, a thermoformable PU foam, or an integral PU foam.

3. The process according to claim 1, wherein the reaction is carried out using
f) water,
g) one or more organic solvents,
h) one or more stabilizers against oxidative degradation,
i) one or more flame retardants, and/or
j) one or more further additives.

4. The process according to claim 1, wherein the foam stabilizer is selected from the group consisting of silicon compounds that include carbon atoms, compounds described by the formula (1c), and mixtures of two or more of said compounds:
[R¹₂R²SiO_{1/2}]ₐ[R¹₃SiO_{1/2}]_{b}[R¹₂SiO_{2/2}]_{c}[R¹R²SiO_{2/2}]_{d}[R³SiO_{3/2}]ₑ[SiO_{4/2}]_{f}Gg Formula (1c):
with
a=0 to 12,
b=0 to 8,
c=0 to 250,
d=0 to 40,
e=0 to 10,
f =0 to 5,
g =0 to 3,
where:
$$a + b + c + d + e + f + g > 3 ,$$
$$a + b \geq 2 ,$$
G=independently identical or different radicals consisting of
(O_{1/2})ₙSiR¹ₘ—CH₂CHR⁵—R⁴—CHR⁵CH₂—SiR¹ₘ(O_{1/2})ₙ,
(O_{1/2})ₙSiR¹ₘ—CH₂CHR⁵—R⁴—CR⁵=CH₂,
(O_{1/2})ₙSiR¹ₘ—CH₂CHR⁵—R⁴—CR⁵=CR⁵—CH₃,
R⁴=independently identical or different divalent organic radicals, optionally interrupted by ether, ester, amide or (—SiR¹₂O—)ₓSiR¹₂ groups and optionally functionalized with OH groups,
x=1 to 50,
R⁵=independently identical or different alkyl radicals consisting of alkyl radicals having 1 to 16 carbon atoms, aryl radicals having 6 to 16 carbon atoms, or hydrogen,
where:
$$n = 1 or 2 ,$$
$$m = 1 or 2 ,$$
$$n + m = 3 ,$$
R¹=identical or different radicals selected from the group of saturated or unsaturated alkyl radicals having 1 to 16 carbon atoms, aryl radicals having 6 to 16 carbon atoms, hydrogen, or —OR⁶,
R²=independently identical or different polyethers obtainable by the polymerization of ethylene oxide, propylene oxide, and/or other alkylene oxides having the general formula (2) or an organic radical corresponding to formula (3)
—(R⁷)ₕ—O—[C₂H₄O]ᵢ—[C₃H₆O]ⱼ—[CR⁸₂CR⁸₂O]ₖ—R⁹, (2)
—Oₕ—R¹⁰, (3)
where
h=0or 1,
R⁷=divalent organic radical, optionally substituted with —OR⁶, where
i=0to 150,
j=0 to 150,
k=0 to 80,
p=1 to 18,
where
$$i + j + k \geq 3 ,$$
R³=identical or different radicals selected from the group of saturated or unsaturated alkyl radicals potentially substituted with heteroatoms,
R⁶=identical or different radicals selected from the group of saturated or unsaturated alkyl radicals having 1 to 16 carbon atoms, aryl radicals having 6 to 16 carbon atoms, or hydrogen,
R⁸=identical or different radicals selected from the group of alkyl radicals having 1 to 18 carbon atoms, potentially substituted with ether functions and potentially substituted with heteroatoms, aryl radicals having 6 to 18 carbon atoms, potentially substituted with ether functions, or hydrogen,
R⁹=identical or different radicals selected from the group hydrogen, alkyl, —C(O)—R¹¹, —C(O)O—R¹¹, or —C(O)NHR¹¹, saturated or unsaturated, optionally substituted with heteroatoms,
R¹⁰=identical or different radicals selected from the group of saturated or unsaturated alkyl radicals or aryl radicals potentially substituted with OH, ether, epoxide, ester, amine and/or halogen substituents,
R¹¹=identical or different radicals selected from the group of saturated or unsaturated alkyl radicals having 1 to 16 carbon atoms or aryl radicals having 6 to 16 carbon atoms.

5. The process according to claim 1, wherein the at least one or more catalysts for production of the PU foam is at least one selected from the group consisting of triethylenediamine, 1,4-diazabicyclo[2.2.2]octane-2-methanol, diethanolamine, N-[2-[2-(dimethylamino)ethoxy]ethyl]-N-methyl-1,3-propanediamine, 2-[[2-(2-(dimethylamino)ethoxy)ethyl]methylamino]ethanol, 1,1′-[(3-{bis[3-(dimethylamino)propyl]amino}propyl)imino]dipropan-2-ol, [3-(dimethylamino)propyl]urea, 1,3-bis[3-(dimethylamino)propyl]urea, and amine catalysts of general structure (1a) and/or of structure (1b): 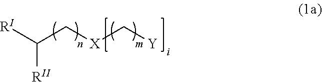
where:
X comprises oxygen, nitrogen, hydroxyl, amino groups of the structure NR^{III} or NR^{III}R^{IV}, or urea groups (N(R^{V})C(O)N(R^{VI}) or N(R^{VII})C(O)NR^{VI}R^{VII}),
Y comprises amino groups NR^{VIII}R^{IX} or alkoxy groups OR^{IX},
R^{I,II} comprise identical or different, linear or cyclic, aliphatic or aromatic hydrocarbon groups having 1-8 carbon atoms that are optionally functionalized with an OH group and/or comprise hydrogen,
R^{III-IX} comprise identical or different, linear or cyclic, aliphatic or aromatic hydrocarbon groups having 1-8 carbon atoms that are optionally functionalized with an OH group, an NH or NH₂ group, and/or comprise hydrogen,
m=0 to 4,
n=2 to 6,
i=0 to 3, 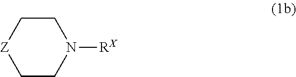
where:
R^{X} comprises at least one identical or different radical selected from the group consisting of hydrogen and linear, branched, or cyclic, aliphatic or aromatic hydrocarbon groups having 1-18 carbon atoms, which may be substituted with 0-1 hydroxyl groups and 0-1 NH₂ groups, Z comprises oxygen, N-R^{X} or CH₂,
and/or
metal compounds including organometallic metal salts, organic metal salts, inorganic metal salts, organometallic compounds, and mixtures thereof of the metals Sn, Bi, Zn, Al or K.

6. The process according to claim 1, wherein, based on the total at least one polyol component, more than 30% by weight of recycled polyol is used, wherein the recycled polyol comprises toluene 2,4-diamine, toluene 2,6-diamine, 2,2′-diaminodiphenylmethane, 2,4′-diaminodiphenylmethane and/or 4,4′-diaminodiphenylmethane in a total amount of 0.00001% to 0.4% by weight based on the total recycled polyol.

7. The process according to claim 1, wherein the recycled polyol was obtained from a polyurethane hydrolysis comprising the reaction of the polyurethane with water in the presence of a base-catalyst combination (I) or (II),
where (I) comprises a base having a pK_{b} at 25° C. of 1 to 10 and at least one catalyst selected from the group consisting of quaternary ammonium salts containing an ammonium cation comprising 6 to 30 carbon atoms and organic sulfonates containing at least 7 carbon atoms,
or where (II) comprises a base having a pK_{b} at 25° C. of <1 and at least one catalyst selected from the group consisting of quaternary ammonium salts containing an ammonium cation having 6 to 14 carbon atoms in the case of an ammonium cation that does not contain a benzyl substituent, and an ammonium cation having 6 to 12 carbon atoms in the case of an ammonium cation that contains a benzyl substituent.

8. A composition suitable for production of a polyurethane foam, comprising:
at least one polyol component that comprises a recycled polyol, at least one isocyanate component, a catalyst, a foam stabilizer, a blowing agent and optionally auxiliaries,
wherein the employed recycled polyol comprises toluene 2,4-diamine, toluene 2,6-diamine, 2,2′-diaminodiphenylmethane, 2,4′-diaminodiphenylmethane and/or 4,4′-diaminodiphenylmethane in a total amount of 0.00001% to 0.4% by weight based on the total recycled polyol.

9. A polyurethane foam, wherein it is obtained by the process according to claim 1.

10. A method for manufacturing products containing a PU foam, the method comprising:
constructing the products with a PU foam according to claim 9, and wherein the products comprise refrigerator insulation, insulation panels, sandwich elements, pipe insulation, imitation wood, mattresses, furniture cushioning, automotive seat cushioning, headrests, instrument panels, automotive interior trim, automotive headlining, sound absorption material, steering wheels, shoe soles, carpet backing foam, and filter foams.

11. The process according to claim 1, wherein the recycled polyol is present in an amount of 0.00005% to 0.1% by weight, based on the total recycled polyol.

12. The process according to claim 1, wherein the PU foam is a hot-cure flexible PU foam.

13. The process according to claim 3, wherein the one or more stabilizers against oxidative degradation are antioxidants.

14. The process according to claim 3, wherein the one or more further additives are at least one selected from the group consisting of surfactants, biocides, dyes, pigments, fillers, antistatic additives, crosslinkers, chain extenders, cell openers, fragrances, cell expanders, plasticizers, hardening promoters, aldehyde scavengers, additives for resistance of PU foams to hydrolysis, compatibilizers (emulsifiers), adhesion promoters, hydrophobization additives, flame-lamination additives, additives for preventing cold flow, and additives that reduce compression set, and odour-reducers.

15. The process according to claim 4, wherein a=0 to 8, b=0 to 2, c=1.5 to 150, d=0 to 20, e=0 to 6, f=0, and g=0 to 2.

16. The process according to claim 4, wherein i=1 to 80, j=0 to 80, k=0, and p=3 or 4.

17. The process according to claim 5, wherein m=2 or 3, n=2 or 3, and i=0 to 2.

18. The process according to claim 5, wherein the metals are Sn or Bi.

19. The process according to claim 6, wherein, based on the total employed polyol component, 95% by weight of recycled polyol is used.

20. The composition according to claim 8, wherein the auxiliaries are surfactants, biocides, dyes, pigments, fillers, antistatic additives, crosslinkers, chain extenders, cell openers, or fragrances.
